(19) United States
(12) Patent Application Publication
(10) Pub. No.: US 2024/0124625 A1
(43) Pub. Date: Apr. 18, 2024

(54) COMPOSITION HAVING SYNTHETIC HYDROCARBON PROCESS OIL

(71) Applicant: Novvi LLC, Alameda, CA (US)

(72) Inventors: Eduardo BARALT, Houston, TX (US); Jeremy AUSTIN, Malvern, PA (US); Jason WELLS, Fremont, CA (US); Jason Charles ROSALLI, Oakland, CA (US)

(21) Appl. No.: 18/380,446

(22) Filed: Oct. 16, 2023

Related U.S. Application Data
(60) Provisional application No. 63/416,798, filed on Oct. 17, 2022.

(51) Int. Cl. C08F 36/08; C08F 12/08; C08F 36/06; C08K 5/01

(52) U.S. Cl. CPC C08F 36/08; C08F 12/08; C08F 36/06; C08K 5/01

(57) ABSTRACT

The present disclosure provides, inter alia, a polymer and oil composition comprising a polymer component, and a synthetic hydrocarbon process oil with a unique branching composition which can be derived from naturally occurring sustainable sources.

### CROSS-REFERENCE TO RELATED APPLICATIONS

This application claims priority to U.S. Provisional Patent Application Ser. No. 63/416,798, filed Oct. 17, 2022, the disclosure of which is herein incorporated by reference in its entirety.

### FIELD OF THE INVENTION

Aspects of the present disclosure relate to a composition comprising a polymer component, and a synthetic hydrocarbon process oil with a unique branching composition which can be derived from naturally occurring sustainable sources. The composition of the present disclosure may be capable of achieving greater thermal stability, UV stability, and exhibiting longer in-service life than materials having polymer components combined with conventional paraffinic oils derived from petroleum distillates.

### BACKGROUND OF THE INVENTION

Plastic and rubber articles made using selected TPE or EPDM polymers often require the use of process oils to achieve desired softness characteristic (lack of hardness) and/or ductile properties. For example, plastic applications such as toothbrushes and shaving razors, when coming into contact with water, can be slippery in the users' hand if made of a hard plastic. Shoe soles are required to balance abrasion resistance, flexibility, and wet traction characteristics to perform. Seals and gaskets produced from EPDM need to conform to form a good seal. In each application, a process oil is added to the composition to achieve the desired hardness and ductility.

Addition of process oils, particularly those derived from petroleum distillates, do suffice in achieving basic properties, but do so at the expense of the broader mechanical properties and in-service life. A particular detriment of conventional process oils is the vast spectrum of molecular weights, molecular structures and impurities that compromise in-service performance.

Accordingly, a need exists for a process oil that maximizes immediate plasticization effect and delivers longer in-service life to components. One with reduced molecular weight diversity, reduced UV-active species, and reduced volatility.

### SUMMARY OF THE INVENTION

Disclosed herein are improved polymer and oil compositions, as well as methods of making and using such synthetic hydrocarbon process oil compositions.

Thermoplastic vulcanizate compositions (TPVs) typically include a rubber component, a thermoplastic component, Process oils and other ingredients such as curing additives and the like. Specific examples of TPVs are seen in U.S. Pat. No. 6,288,171, which is hereby incorporated by reference herein. A variety of properties of TPVs are considered to be important, including but not limited to rebound, tensile strength and elongation, as well as varying degrees of softness or hardness. One of the many challenges in making TPVs is to obtain the right balance of properties. The type, quality, molecular structure, and quantity of process oil used need to be carefully considered to obtain the desired product properties.

Many process oils are derived from petroleum fractions and have particular ASTM designations depending on whether they fall into the class of paraffinic, naphthenic, or aromatic oils or mixtures there off. Examples of such petroleum-based process oil are ParaLux® and ParaFlex®. Other types of additive oils, which can be used in the TPVs, are alpha olefinic synthetic oils, such as liquid polybutylene, e.g., products sold under the trademark Parapol®. The type of additive oil utilized will be that customarily used in conjunction with a particular rubber component.

The quantity of process oil can be based on the total rubber content, and defined as the ratio, by weight, of additive oil to total rubber in the TPVs, and that amount may in certain cases be the combined amount of process oil (typically added during processing) and extender oil (typically added after processing). The ratio may range, for example, from about 0 to about 4.0/1 by weight of process oil to rubber in the TPVs. Larger amounts of additive oil can be used, although the deficit is often reduced physical strength of the composition, or oil weeping, or both.

Process oils other than petroleum-based oils can be used also, such as oils derived from coal tar and pine tar, as well as synthetic oils, e.g., polyolefin materials (e.g., Nexbase™, supplied by Fortum Oil and Gas Oy). Examples of plasticizers that are often used as additive oils are organic esters and synthetic plasticizers. Certain rubber components (e.g., EPDMs, such as Vistalon 3666) include additive oil that is preblended before the rubber component is combined with the thermoplastic.

Generally, the process oil is typically selected from paraffinic oils, aromatic oils, naphthenic oils, and polybutene oils. Polybutene process oil is a low molecular weight (less than 15,000 Mn) homopolymer or copolymer of olefin-derived units having from about 3 to about 8 carbon atoms, more preferably about 4 to about 6 carbon atoms. The polybutene oil can also be a homopolymer or copolymer of a raffinate stream.

Low molecular weight “polybutene′ polymers are described in, for example, SYNTHETIC LUBRICANTS AND HIGH-PERFORMANCE FUNCTIONAL FLUIDS 357-392 (Leslie R. Rudnick & Ronald L. Shubkin, ed., Mar cel Dekker 1999.) Typical useful examples of polybutene oils are the PARAPOL™ series of processing oils (previously available form ExxonMobil Chemical Company, Houston Tex., now available from Infineum International Limited, Milton Hill, England under the “INFINEUM c, d, for g tradename), including grades previously identified as PARAPOL™ 450, 700,950, 1300, 2400, and 2500. In certain embodiments, preferred polybutene oils can include SUNTEX™ polybutene oils available from Sun Chemicals. According to certain embodiments, preferred polybutene processing oils are typically synthetic liquid polybutenes having a certain molecular weight, preferably from about 420 Mn to about 2700 Mn. The molecular weight distribution Mw/Mn (“MWD”) of preferred polybutene oils, according to certain embodiments, is typically about from 1.8 to about 3, preferably about 2 to about 2.8. According to certain embodiments, the preferred density (g/ml) of useful polybutene processing oils varies from about 0.85 to about 0.91. The bromine number (CG/G) for preferred polybutene oils, in some embodiments, ranges from about 40 for the 450 Mn process oil, to about 8 for the 2700 Mn process oil.

Rubber process oils also have ASTM designations depending on whether they fall into the class of paraffinic, naphthenic or aromatic hydrocarbonaceous process oils. The type of process oil utilized will be that customarily used in conjunction with a type of polymer component, and a rubber chemist of ordinary skill in the art will recognize which type of oil should be utilized with a particular polymer component, such as a type of rubber, in a particular application. Suitable hydrocarbon process oils for use in such inner liners include oils having the following general characteristics.

Traditional paraffinic process oils are composed of approximately 70% paraffinic material and 30% naphthenic compounds, where the target viscosity is dependent on the application. A paraffinic process oil suitable for the application disclosed herein may have the following target characteristics:
Viscosity (cSt) at 100° C. per ASTM D445: 3.5 to 10 cSt
Aniline point, ° C. per ASTM D611: >100
Flash point, ° C. per ASTM ASTM D92: >230 ASTM D92
Pour point, ° C. per D5950: <−21

### Definitions

As used herein, “polymer” refers to a substance or material made up of repeating subunits with number average molecular weight of greater than 100,000 amu.

As used herein, an “alpha-olefin” used in the synthesis of the synthetic hydrocarbon process oil of the present disclosure may be produced by oligomerization of ethylene derived from dehydration of ethanol produced from a renewable carbon source. In some variations, an alpha-olefin used in the oligomerization as a co-monomer may be produced by dehydration of a primary alcohol other than ethanol that is produced from a renewable carbon source. Said renewable alcohols can be dehydrated into olefins using several known dehydration acidic catalysts such as phosphoric acid, sulfuric acid and heterogeneous catalyst such as alumina.

As used herein, non-polar “Thermoplastic Elastomer (TPE)”, sometimes referred to as “thermoplastic rubbers”, are a class of copolymers or a physical mix of polymers (usually a plastic and a rubber) that consist of materials with both thermoplastic and elastomeric properties. An example of a TPE is Ethylene-Propylene Diene Monomer (EPDM): EPDM rubber is a type of synthetic rubber that is used in many applications. EPDM is an M-Class rubber under ASTM standard D-1418-22; the M class comprises elastomers having a saturated chain of the polyethylene type. Other thermoplastic elastomers may include EP-norbornene, Styrene Isoprene copolymers, TPS (SBS & SEBS), TPO, TPU, and hydrogenated styrene farnesene copolymers among other polymers.

As used herein, “thermoplastic vulcanizate compositions (TPVs)” are polymers made from monomers such as ethylene, propylene, and a diene comonomer that enables crosslinking via sulfur vulcanization. Vegetable oil can also be vulcanized to make biobased TPVs. Typically, TPVs include a rubber component, a thermoplastic component, Process oils and other ingredients such as curing additives and the like.

As used herein, the term “rubber component” broadly means any material that is considered by persons skilled in the art to be a rubber (preferably a cross linkable polymer). In addition to natural rubber, rubber components include, without limitation, any olefin-containing rubber such as ethylene-propylene copolymers (EPM), including particularly saturated compounds that can be vulcanized using free radical generators such as organic peroxides, as noted in U.S. Pat. No. 5,177,147, which is incorporated herein by reference. Other rubber components are ethylene-propylene-diene (EPDM) rubber, or EPDM-type rubber. Random propylene copolymers, RPCs, can also be used as the rubber component as referenced in U.S. Pat. No. 6,288,171, which is incorporated herein by reference. Butylated polymers and their derivatives as well as other polymers described in U.S. Pat. No. 7,294,675, which is incorporated herein by reference, can act as the rubber component of the thermoplastic composition.

The term “vulcanization” is used herein in its commonly accepted sense and as reference to the process of converting a natural or synthetic rubber from the raw state in which it is a weak material having the typical properties of a plastic gum, into a strong, non-plastic typically elastic material.

NMR Branching Analysis. The branching parameters of the synthetic hydrocarbon process oil of the present disclosure are measured by Nuclear Magnetic Resonance (NMR) spectroscopy. Some critical characterizations include:
Branching Index (BI): the percentage of methyl hydrogens appearing in the chemical shift range of 0.5 to 1.05 ppm among all hydrogens appearing in the ¹H NMR chemical range 0.5 to 2.1 ppm in a hydrocarbon oligomer.
Branching Proximity (BP): the percentage of recurring methylene carbons which are four or more number of carbon atoms removed from an end group or branch appearing at ¹³C NMR chemical shift 29.8 ppm in a hydrocarbon oligomer.
Internal Alkyl Carbon branches: the number of methyl, ethyl, or propyl carbons which are three or more carbons removed from end methyl carbons, that includes 3-methyl, 4-methyl, 5+methyl, adjacent methyl, internal ethyl, n-propyl and unknown methyl appearing between ¹³C NMR chemical shift 0.5 ppm and 22.0 ppm, except end methyl carbons appearing at 13.8 ppm.
Internal methyl branch: an internal alkyl carbon branch that is only a single carbon in length.
5+ Methyl branch: a methyl carbon attached to a tertiary carbon which is more than four carbons away from an end carbon appearing at 13 C NMR chemical shift 19.6 ppm in an average isoparaffinic molecule.

FIMS Analysis. The hydrocarbon distribution of hydrocarbon oligomers according to aspects of the current invention are determined by FIMS (field ionization mass spectroscopy). FIMS spectra were obtained on a Waters GCT-TOF mass spectrometer. The samples were introduced via a solid probe, which was heated from about 40° C. to 500° C. at a rate of 50° C. per minute. The mass spectrometer was scanned from m/z 40 to m/z 1000 at a rate of 5 seconds per decade. The acquired mass spectra were summed to generate one averaged spectrum which provides the carbon number distribution of the hydrocarbon oligomer sample.

As used herein, “permittivity (ε)” is a measure of the ability of a material to be polarized by an electric field.

As used herein, the “dielectric constant (k)” of a material is the ratio of its permittivity ε to the permittivity of vacuum.

As used herein, a “low-k dielectric” is a dielectric that has a low permittivity, or low ability to polarize and hold charge. Low-k dielectrics are very good insulators for isolating signal-carrying conductors from each other and for reducing transmission losses when electromagnetic.

As used herein, the “dissipation factor (DF)” is a measure of loss-rate of electro-magnetic energy within a dielectric material at a given frequency.

As used herein, “5G” refers to the fifth-generation telecommunication technology standard for broadband cellular networks, which cellular phone companies began deploying worldwide in 2019, and is the planned successor to the 4G networks.

As used herein, the “loss modulus” is a measure of the viscous response of a material, also called the imaginary modulus or out of phase component.

As used herein, the “storage modulus” is a measure of the elastic response of a material (but not the same as Young's modulus), and is also called the in-phase component.

### BRIEF DESCRIPTION OF THE DRAWINGS

FIG. 1 is a UV absorbance spectrum showing reduced UV absorbance of the synthetic hydrocarbon process oils in the UV wavelength characteristic of polar species, compared to commercially available paraffinic process oils.

FIG. 2 shows the simulated distillation of synthetic hydrocarbon process oil compared to traditional paraffinic process oils. The higher boiling point and more narrow boiling point distribution leads to reduced volatile and semi volatile components, resulting in improved fogging and other volatility results.

### DETAILED DESCRIPTION

One aspect of the present disclosure relates to a polymer and oil composition comprising: a polymer component, and a synthetic hydrocarbon process oil comprising hydrocarbon oligomers, wherein the synthetic hydrocarbon process oil is present in an amount of from 5 to 80 wt % of the composition. According to certain embodiments, the polymer and oil composition according to the present disclosure contains the synthetic hydrocarbon process oil with a unique branching structure, which is used as a process oil in the polymer and oil composition in an amount of 5 to 75 wt % of the composition. According to certain embodiments, the advantages imparted by the improved polymer and oil compositions can include any of greater compatibility with non-polar polymers, improved fogging characteristics, greater UV stability, and improved mechanical properties. According to certain embodiments, the polymer and oil composition comprises a synthetic hydrocarbon process oil that is a synthetic hydrocarbon mixture having a unique branching structure. According to certain embodiments, said synthetic hydrocarbon process oil may have an extremely high initial boiling point (IBP) for a given viscosity, where the initial boiling point is measured by ASTM D6352-19 and is defined as the simulated temperature where 0.5 wt % of the substance boils. According to further embodiments, the synthetic hydrocarbon process oil can comprise a narrow molecular weight. According to another embodiment, the synthetic hydrocarbon process oil can comprise a high degree of saturation. According to another embodiment, the synthetic hydrocarbon process oil can comprise a relative lack of aromatics and impurities. In certain embodiments, characteristics such as those described herein are important performance attributes for a synthetic hydrocarbon process oil intended for use in a thermoplastic elastomer composition.

According to certain embodiments, the synthetic hydrocarbon process oil comprises a mixture of hydrocarbon oligomers. For example, in one embodiment, the synthetic hydrocarbon process oil is characterized by having greater than 80% of the molecules with an even carbon number according to FIMS. In another embodiment, the synthetic hydrocarbon process oil comprises a unique branching structure characterized by NMR of Branching Proximity (BP) of 22-35. In certain embodiments of the present disclosure, the branching structure is further defined by NMR to have a BP/BI in the range of ≥-0.6037(internal alkyl branching per molecule)+2.0. In a further embodiment, the synthetic hydrocarbon process oil has, on average, at least 0.3 to 1.5 5+ methyl branches where the internal methyl branches located more than four carbons away from the end carbon.

In one embodiment, the hydrocarbon mixtures described herein are the product of oligomerization of olefins and optionally a subsequent hydroisomerization. According to one embodiment, C₁₄ to C₂₀ olefins are oligomerized to form an oligomer mixture comprising a distribution consisting of unreacted monomer, dimers (C₂₈-C₄₀), and trimers and higher oligomers (≥C₄₂). According to certain embodiments, the unreacted monomers are distilled off and may be used for possible reuse, such as in a subsequent oligomerization. According to further embodiments, the oligomer mixture may then undergo subsequent isomerization, such as a part of a hydroisomerization process, to achieve desired branching properties. According to certain embodiments, oligomerization conditions may also be selected to provide for at least partial isomerization during oligomerization, and which may be followed an optional subsequent isomerization. In one embodiment, the hydroisomerization process results in a saturated oligomer mixture.

In another embodiment, a further hydrogenation process can be performed to further saturate the oligomer mixture to provide the final synthetic hydrocarbon process oil product. According to one embodiment, synthetic hydrocarbon process oil comprises the dimer fraction of the oligomer mixture, for example as isolated from the oligomer mixture before or after isomerization and/or hydrogenation. According to certain embodiment, the isolated dimer fraction will have an average carbon number for the dimers between 28 and 40. In some embodiments, the isolated dimer fraction of the synthetic hydrocarbon process oil could be comprised of any combination of two alpha olefins with even carbon numbers between 14 and 20 carbons. In some embodiments, the synthetic hydrocarbon process oil comprises at least 95 wt % dimers of alpha olefin mixtures. In some embodiments, the synthetic hydrocarbon process oil comprises 5 wt % or less of trimer or higher oligomers. In some embodiments, the synthetic hydrocarbon process oil is comprised of 95 wt % dimers, and has a kinematic viscosity at 100° C. (KV100) between 3 to 5 cSt, and an initial boiling point of greater than 350° C. In some embodiments, the synthetic hydrocarbon process oil has a KV100 of 3 to 5 cSt, with a Noack volatility by ASTM D5800 of less than 18%. In another embodiment, the synthetic hydrocarbon process oil has a KV100 of 3 to 5 cSt, with a Noack volatility of less than 8%. In some embodiments, the synthetic hydrocarbon process oil has a kinematic viscosity at 100° C. (KV100) of 3 to 5 cSt, a Noack volatility of 8%, and an initial boiling point >385° C. In some embodiments, the synthetic hydrocarbon process oil has a kinematic viscosity at 100° C. (KV100) of 7 to 10 cSt, a Noack volatility of <3%, and an initial boiling point >435° C.

In yet another embodiment, the synthetic hydrocarbon process oil may comprise an isolated trimer and higher oligomer fraction of the oligomerization process, for example as isolated from the oligomer mixture before or after isomerization and/or hydrogenation. According to certain embodiments, the isolated trimer and higher oligomer fraction have an average carbon number greater than 42 or C₁₄ trimer. In some embodiments, the isolated trimer and higher oligomer fraction is composed of any combination of alpha olefins with even carbon numbers between 14 to 20 carbons in length and is at least 95 wt % of trimer and higher oligomers, and/or 5 wt % dimers. In some embodiments, the synthetic hydrocarbon process oil is comprised of at least 95 wt % trimer and higher oligomers, and has a kinematic viscosity at 100° C. (KV100) between 7 and 10 cSt and an initial boiling point greater than 435° C. In some embodiments, the synthetic hydrocarbon process oil has a KV100 of 7 to 10 cSt, with a Noack volatility of less than 6%, as determined by ASTM D5800. In another embodiment, the synthetic hydrocarbon process oil has a KV100 of 7 to 10 cSt, with a Noack volatility of less than 3%. The manufacture of the synthetic hydrocarbon is detailed in U.S. Pat. No. 11,247,948, which is incorporated herein by reference in its entirety.

In one embodiment, the synthetic hydrocarbon process oil comprises a dimer of C₁₄-C₂₀ alpha olefins. In another embodiment, the synthetic hydrocarbon process oil comprises a dimer of C₁₄ alpha olefins. In another embodiment, the synthetic hydrocarbon process oil comprises a dimer of C₁₆ alpha olefins. In yet another embodiment the synthetic hydrocarbon process oil comprises a dimer of C₁₄ and C₁₆ alpha olefins. In another embodiment, the synthetic hydrocarbon process oil has an average of is 24-40 carbons per hydrocarbon oligomer. In another embodiment, the synthetic hydrocarbon process oil has an average of 24 carbon atoms per hydrocarbon oligomer. In another embodiment, the synthetic hydrocarbon process oil has an average of 32 carbon atoms per hydrocarbon oligomer. In another embodiment, the synthetic hydrocarbon process oil has an average of 30 carbon atoms per hydrocarbon oligomer. In another embodiment, the synthetic hydrocarbon process oil comprises at least 95% by weight of hydrocarbon oligomers having an average carbon number of 24-40 carbon atoms, 24-32 carbon atoms, 24 carbon atoms, 30 carbon atoms, or 32 carbon atoms. In another embodiment, the synthetic hydrocarbon process oil is a mixture of trimer and higher oligomer with an average carbon number greater than or equal to 42.

According to certain embodiments, alpha olefins used to produce the synthetic hydrocarbon process oil herein can be derived from renewable sources. In one embodiment, the dehydration of renewable primary alcohols is detailed in U.S. Pat. No. 11,247,948, alpha olefins created from the dehydration process can be used for the oligomerization step. The alpha olefins used in the dehydration process may be created from renewable sources. The resulting synthetic hydrocarbon process oil from the renewable alpha olefins would be made in part or entirely from renewable carbon. The quantity of renewable carbon can be assessed by ASTM D6844-10(2019).

According to certain embodiments, the polymer and oil composition according to aspects of the present disclosure contains a synthetic hydrocarbon process oil with a unique branching structure, which is used as a process oil in the polymer and oil composition in an amount of 5 to 75 wt % per 100% of the blend of polymer components.

According to one embodiment, the synthetic hydrocarbon process oil comprises a hydrocarbon mixture as described in U.S. Pat. No. 11,041,133 issued on Jun. 22, 2021, which is hereby incorporated by reference herein in its entirety. According to yet another embodiment, the synthetic hydrocarbon process oil comprises a base oil having hydrocarbon oligomers as described in any one or more of U.S. Pat. No. 11,332,690 issued on May 17, 2022, and U.S. PG-Publication No. 2020/0216772 published on Jul. 9, 2020, each of which is hereby incorporated by reference herein in its entirety.

According to aspects herein, the polymer and oil composition of the present disclosure may include one or more compatible rubbers. According to another aspect, the polymer and oil composition may include additives such as: particulate filler organic and inorganic, organic or inorganic pigments, reinforcing additives, nucleating agents, scorch retarding agents, crosslinking agents, crosslinking co-agents, antioxidants, internal and external lubricating agents, thermal stabilizers, UV-stabilizers, conductive additives, flame retardant additives, and anti-static agents. In one embodiment, the polymer and oil compositions comprising EPDM compositions can include peroxide curing agent, and may also include polyolefins, curing co-agents, antioxidants, scorch retardants, inorganic fillers, organic fillers, and/or waxes. Auxiliary components are not directly part of the invention, but in specific cases the addition of the synthetic hydrocarbon process oil exhibits a synergy with auxiliary components to achieve better performance than would be expected with conventional petroleum distillate process oils.

In some embodiments, the polymer component of the composition is non-polar. In some embodiments, the polymer component is a rubber compatible with the synthetic hydrocarbon process oil. For example, in one embodiment, rubbers compatible with the synthetic hydrocarbon process oil include but not limited to Polypropylene co-polymers, Ethylene-propylene co-polymer (EPM), Ethylene-propylene-diene (EPDM), SBR—Styrene Butadiene rubber, SEBS—Styrene-ethylene-butylene, HSBC—hydrogenated styrenic block co-polymers, RPC—random polypropylene co-polymers, NR-natural rubber, Butyl Rubber, Chloro-neoprene, and styrene isoprene copolymer. In certain embodiments of the present disclosure, the synthetic hydrocarbon process oil is used in a compound where the polymer component is crosslinked through a process of vulcanization. In certain embodiments, the elastomeric component may be a blend of two or more polymers where at least one or more of the elastomers is compatible with the synthetic hydrocarbon process oil.

According to certain embodiments, over time, and under duress, the synthetic hydrocarbon process oil will remain within the elastomeric composition, whereas traditional paraffinic process oils that contain a wider spectrum a molecular weights and molecular structures will demonstrate instability of low (migratory) and high (incompatible) fractions.

According to one embodiment, the synthetic hydrocarbon process oil contains little or no polar species that are otherwise found in traditional paraffinic process oils, such as aromatic or polyaromatic compounds, olefinic, naphthenic, or oxygenated compounds. Without being limited to any one theory, it is believed that the reduced number and/or absence of polar species imparts enhanced UV stability and/or reduces the decomposition of the elastomer composition that may otherwise occur in the presence of such species. For example, the synthetic hydrocarbon process oil having little or no polar species will generally not create or propagate any free-radical species resulting from exposure to UV light, and so may provide for reduced discoloration and reduced failure of the elastomer composition having the synthetic hydrocarbon process oil.

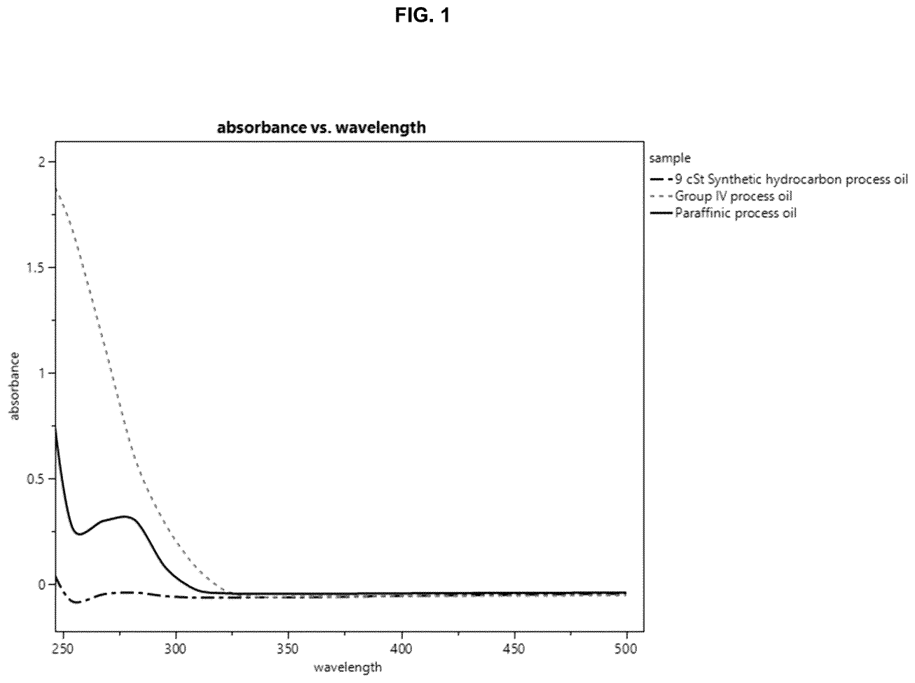

As shown in FIG. 1 the synthetic hydrocarbon process oil has near zero UV absorbance from 250 to 50 nm, demonstrating that the synthetic hydrocarbon process oil lacks the polar species typically found in traditional paraffinic process oils. More specifically, the low absorbance at 272 nm by ASTM D2269-10 denotes the lack of aromatic material in the synthetic hydrocarbon process oil. Aromatics are known to be UV-active and can degrade when exposed to UV for extended periods of time. In certain embodiments of the present disclosure, the synthetic hydrocarbon process oil has a UV absorbance at 272 nm which is less than 0.5 and more preferably less than 0.3, as determined according to ASTM D2269-10.

To demonstrate the relative UV stability of the Synthetic hydrocarbon process oil, where the UV-Absorbance by ASTM D2269-10 is less than 0.1 at 272 nm, 6.5 g of Synthetic hydrocarbon process oil as disclosed herein, and a conventional group IV process oil, with a UV-absorbance by ASTM D2269-10 of 1.0 at 272 nm, were exposed to a specific UV-light source for 24 hrs, where the UV bulb was 400 W and 120,000 lux with a 910 W/m² intensity. Color by Pt/Co-Hazan (ASTM D1209-05) was measured after 3, 6, and 24 hrs. Table 1 shows how a reduced UV-absorbance at 272 nm in the inventive synthetic hydrocarbon process oil resulted in significantly reduced color change during the UV stability testing.

Without being limited to any theory, it is believed that the reduced UV absorbance of the Synthetic hydrocarbon process oil is due to its reduced impurity profile and increased level of saturation. According to certain embodiments, the synthetic hydrocarbon of the disclosure has a bromine index of less than 200 mgBr/100 g, and more preferably a bromine index of less 100 mgBr/100 g as measured by ASTM D2710-20. In contrast, the Group IV process oil as tested exhibited a bromine index of 400 mgBr/100 g.

TABLE 1

| | | | | | Bromine |
|---|---|---|---|---|---|
| | | | | | Index, |
| | | | | | ASTM |
| | Initial | Pt/Co- | Pt/Co- | Pt/Co- | D2710 |
| | Pt/Co- | Hazen, | Hazen, | Hazen, | (mgBr/ |
| Sample | Hazen | 3 hr | 6 hr | 24 hr | 100 g) |
| Example 1 | 3 | 4 | 4 | 4 | <100 |
| 8 cSt Group IV | 3 | 14 | 14 | 20 | 400 |

According to certain embodiments, the process oil can be added to achieve a particular tactile property characterized by hardness. As the synthetic hydrocarbon process oil demonstrates greater compatibility, the entirety of the process oil is contributing to the plasticization effect. Consequently, according to certain embodiments, a softer elastomer composition can be achieved with a prescribed loading level as compared to conventional process oils. Furthermore, according to certain embodiments, a more reproducible hardness may be achieved, such as by virtue of narrow molecular weight and reduced isomeric structures of the synthetic hydrocarbon process oil compared to other paraffinic process oils, and therefore tactile properties can be achieved with greater precision and accuracy.

According to certain embodiments, the synthetic hydrocarbon process oil may be included in the polymer composition to ensure that the polymer composition has good flow properties. The quantity of synthetic hydrocarbon process oil utilized will depend in part on the amount of polymer blend and filler used. According to certain embodiments, the synthetic hydrocarbon process oil may comprise at least about 5 wt %, 10 wt %, 20 wt %, 40 wt %, and/or 80 wt % of the polymer composition. Larger amounts of the synthetic hydrocarbon process oil can also be used.

According to certain embodiments, the polymer and oil compositions comprising the synthetic hydrocarbon process oils herein exhibit improved fogging characteristics. By way of explanation, certain elastomer compositions such as those on the interior of car are exposed to elevated temperatures for extended periods of time. Exposure to these elevated temperatures may cause what is known as fogging to occur. Fogging occurs when volatile or semi-volatile compounds within the elastomer composition volatilize and condense on cooler surfaces such as a windshield. The fogging analysis described by DIN-75201 B can be used to measure the amount of fogging of such an interior component may exhibit. According to DIN-75201 B method, a sample of the synthetic hydrocarbon process oil is placed in a beaker that is then covered with an aluminum foil disk. The disk's mass has been measured and recorded. For a period of sixteen hours the sample is heated to 100° C., while the aluminum foil disk is cooled to 21° C. The heat causes the sample to release semi volatile organic compound gasses that condense on the cooled aluminum foil disk creating a “Fog” that has a measurable mass. The amount of fogging condensate is determined by weighing the aluminum foil disk again after the test and subtracting the known mass of the same aluminum foil disk before fogging. In some embodiments, the synthetic hydrocarbon process oil has a gravimetric fogging value of ≤1, preferably <0.1, as determined according to DIN 75201-B.

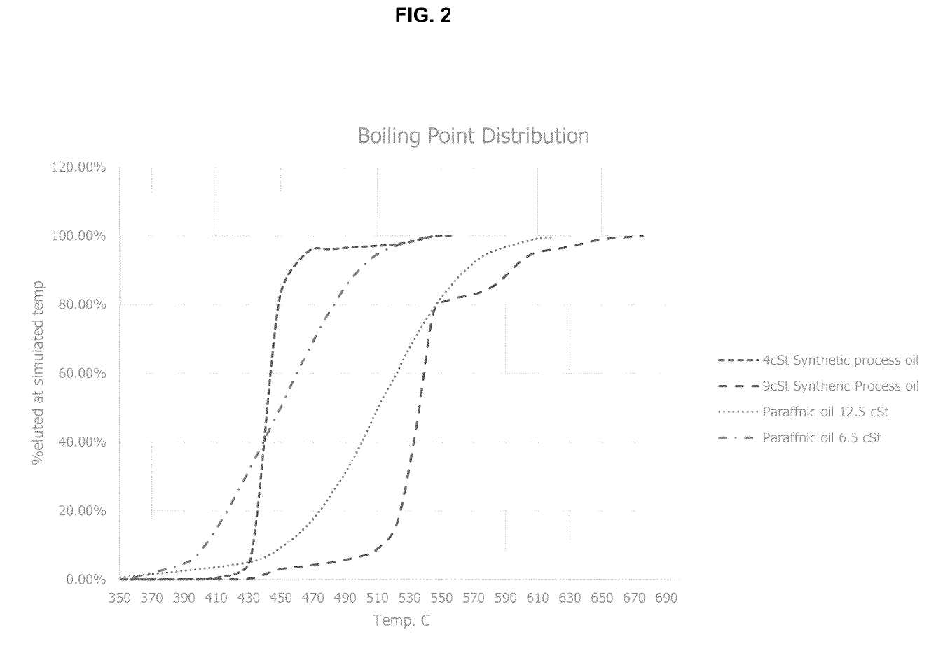

Traditional paraffinic process oils typically have wider boiling point ranges and lower boiling components that contribute to the fogging result of an interior component. In contrast, embodiments of the synthetic hydrocarbon process oil may have a narrower boiling point range and higher initial boiling point as measured by ASTM D6352-19. FIG. 2 shows that more traditional paraffinic process oils of even higher viscosities have a lower initial boiling point than the synthetic hydrocarbon process oil according to embodiments herein. The lower initial boiling point of traditional paraffinic process oil will lead to more volatilization of volatile and semi volatile compounds. This increases the fogging and results in more loss for any relevant volatilization method.

An example of the manufacture of a 4 cSt synthetic hydrocarbon process oil tested with 399° C. initial boiling point was produced using the following method: Hexadecene with 90% alpha olefin and less than 8% branched and internal olefins was oligomerized under BF3 with a co-catalyst composition of Butanol and Butyl Acetate. The reaction was held at 20° C. during semi-continuous addition of olefins and co-catalyst. The residence time was 90 minutes. The unreacted monomer was then distilled off, leaving behind less than 0.1% monomer distillation bottoms. A subsequent distillation was performed to separate the dimer from the trimer+ with less than 5% trimer remained in the dimer cut. The dimers were then hydroisomerized with a noble-metal impregnated aluminosilicate of MRE structure type catalyst bound with alumina. The reaction was carried out in a fixed bed reactor at 500 psig and 307° C. Cracked molecules were separated from the hydroisomerized C₁₆ dimer using an online stripper.

An example of the 9 cSt synthetic hydrocarbon process oil with 445° C. initial boiling point was produced by: Hexadecene with 90% alpha olefins and less than 8% branched and internal olefins was oligomerized under BF3 with a co-catalyst composition of Butanol and Butyl Acetate. The reaction was held at 20° C. during semi-continuous addition of olefins and co-catalyst. The residence time was 90 minutes. The unreacted monomer was then distilled off, leaving behind less than 0.1% monomer distillation bottoms. A subsequent distillation was performed to separate the dimer from the trimer and higher oligomers, the resulting dimer has less than 5% trimer. The trimer and higher oligomers (trimer+) cut were then hydroisomerized with a noble-metal impregnated aluminosilicate of MRE structure type catalyst bound with alumina. The reaction was carried out in a fixed bed reactor at 500 psig and 313° C. Cracked molecules were separated from the hydroisomerized C₁₆ trimer+ using an online stripper. In some embodiments, the synthetic hydrocarbon process oil has a flash point ≥230° C., or ≥270° C. as determined according to ASTM D93.

TABLE 2

| | | Synthetic | | Traditional | |
|---|---|---|---|---|---|
| | | hydrocarbon | | Paraffinic | |
| | ASTM | Process oils | | Process oils | |
| Physical property | method | 4 cSt | 9 cst | 6.5 cSt | 12.5 cSt |
| Kinematic viscosity | ASTM D7042 | 4.4 | 9.45 | 6.5 | 12.1 |
| at 100° C. | | | | | |
| Initial boiling | ASTM D6352 | 399 | 445 | 350 | 358 |
| point, ° C. | | | | | |
| Noack volatility, | ASTM D5800 | 8 | 1.5 | | |
| wt % loss | | | | | |
| Fogging, mg | DIN 75201B | 0.8 | <0.1 | | |
| Flash point, ° C. | ASTM D92 | 235 | 270 | 235 | 257 |
| Aniline point, ° C. | ASTM D611 | 122 | 138 | 125 | 113 |

Recent advances in high-frequency radio communication, such as 5G, have created a need for new dielectric insulators and lower loss materials to enable radio-transparent, low-loss structures, enclosures, encapsulation, and components that can transmit high-frequency signals without absorbing or attenuating the transmitted power. In the application of 5G data and communication, to achieve very high wireless data speeds of greater than 2 Gb/sec, signals are transmitted at higher frequencies (1 GHz to 39 GHz) with bandwidths up to 100 MHz. Under these conditions, signal transmission is significantly impacted by dielectric constant (k) and dissipation factor (Df).

Water adsorption or uptake in polymer dielectric materials can reduce 5G transmission efficiency and/or lower maximum data speeds by increasing the dielectric constant (k) for a given frequency. The trace amount of water within a polymer matrix is correlated with an increase in dielectric constant because of the contribution of water dipoles to the average relaxation time of the dielectric polymer. Narrow molecular weight hydrocarbons with reduced branching of the synthetic hydrocarbon process oil can reduce water uptake and maintain low loss when used to extend or modify the mechanical properties of certain polymer dielectric materials.

Certain elastomeric or viscoelastic materials may utilize process oils to adjust and control mechanical properties. These include flexural, tension, or compression modulus as well as dynamic mechanical properties such as storage and loss modulus. The dynamic properties are often tuned or selected to dampen or absorb structure borne vibrations that produce noise, provide isolation from mechanical shock energy, or block airborne sounds. Synthetic hydrocarbon process oil of the present invention can offer advantages through narrow and precise molecular weight distribution and branching. The narrow molecular weight and uniform branching contributes to lower volatility which enables higher concentration or loading, greater stability over time and temperature, and reduces risk of evaporation or oil bleed. Lower diversity in the branching and chemical structure helps ensure consistent dynamic properties and allows for reproducible compounding to deliver a more precisely tuned dynamic mechanical response and enable engineers to design better viscoelastic bulk materials or composites.

All documents cited in this application are hereby incorporated by reference as if recited in full herein.

Although illustrative embodiments of the present disclosure have been described herein, it should be understood that the disclosure is not limited to those described, and that various other changes or modifications may be made by one skilled in the art without departing from the scope or spirit of the disclosure.

1. A polymer and oil composition, comprising:
a polymer component, and
a synthetic hydrocarbon process oil comprising hydrocarbon oligomers, wherein the synthetic hydrocarbon process oil is present in the composition in an amount of from 5 to 80 wt % of the polymer component, and wherein the synthetic hydrocarbon process oil is defined by
(i) ≥80% of the hydrocarbon oligomers of the synthetic hydrocarbon process oil having even carbon number, as determined according to Field Ionization Mass Spectroscopy (FIMS) analysis, and
(ii) an average Branching Proximity (BP) of the hydrocarbon oligomers of the synthetic hydrocarbon process oil between 22 and 35, as determined by Nuclear Magnetic Resonance (NMR) spectroscopy, where the average Branching Proximity corresponds to the average across all of the hydrocarbon oligomers in the synthetic hydrocarbon process oil of the percentage of the total number of carbon atoms in each hydrocarbon oligomer that are recurring methylene carbon atoms that are four or more removed from an end group or branch (ε carbon atoms) in the hydrocarbon oligomer, as defined below:
branching proximity (BP)=(number of εcarbon atoms/total number of carbon atoms)*100.

2. The composition of claim 1, comprising a ratio of Branching Proximity (BP) to Branching Index (BI) (BP/BI ratio) of the hydrocarbon oligomers of the synthetic hydrocarbon process oil that is ≥-0.6037 (Internal alkyl branching per molecule)+2.0, wherein BI and BP are determined by NMR spectroscopy.

3. The composition of claim 1, wherein the synthetic hydrocarbon process oil has average 0.3 to 1.5 5+ methyl branches per molecule of the hydrocarbon oligomers in the synthetic hydrocarbon process oil.

4. The composition of claim 1, wherein the synthetic hydrocarbon process oil has a gravimetric fogging value of 1, as determined according to DIN 75201-B.

5. The composition of claim 1, wherein the synthetic hydrocarbon process oil has a gravimetric fogging value of <0.1, as determined according to DIN 75201-B.

6. The composition of claim 1, wherein the synthetic hydrocarbon process oil comprises a dimer of alpha olefins.

7. The composition of claim 1, wherein the synthetic hydrocarbon process oil comprises at least 95 wt % of dimers of alpha olefins.

8. The composition of claim 1, wherein the synthetic hydrocarbon process oil comprises less than 5 wt % of trimers and higher oligomers of alpha olefins.

9. The composition of claim 1, wherein the synthetic hydrocarbon process oil comprises at least 95 wt % of trimers and higher oligomers of alpha olefins.

10. The composition of claim 1, wherein the synthetic hydrocarbon process oil comprises less than 5 wt % of dimers of alpha olefins.

11. The composition of claim 1, wherein the synthetic hydrocarbon process oil comprises a dimer of C₁₄-C₂₀ alpha olefins.

12. The composition of claim 1, wherein the synthetic hydrocarbon process oil comprises a dimer of C₁₄ alpha olefins.

13. The composition of claim 1, wherein the synthetic hydrocarbon process oil comprises a dimer of C₁₆ alpha olefins.

14. The composition of claim 1, wherein the synthetic hydrocarbon process oil comprises a dimer of C₁₄ and C₁₆ alpha olefins.

15. The composition of claim 1, wherein the synthetic hydrocarbon process oil has an average of 24-40 carbon atoms per hydrocarbon oligomer.

16. The composition of claim 1, wherein the synthetic hydrocarbon process oil has an average of 24 carbon atoms per hydrocarbon oligomer.

17. The composition of claim 1, wherein the synthetic hydrocarbon process oil has an average of 28 carbon atoms per hydrocarbon oligomer.

18. The composition of claim 1, wherein the synthetic hydrocarbon process oil has an average of 32 carbon atoms per hydrocarbon oligomer.

19. The composition of claim 1, wherein the synthetic hydrocarbon process oil has an average of 30 carbon atoms per hydrocarbon oligomer.

20. The composition of claim 1, wherein the synthetic hydrocarbon process oil comprises at least 95 wt % of hydrocarbon oligomers having an average carbon number of 24-40 carbon atoms.

21. The composition of claim 1, wherein the synthetic hydrocarbon process oil comprises at least 95 wt % of hydrocarbon oligomers having an average carbon number of 24-32 carbon atoms.

22. The composition of claim 1, wherein the synthetic hydrocarbon process oil comprises at least 95 wt % of hydrocarbon oligomers having an average carbon number of 24 carbon atoms.

23. The composition of claim 1, wherein the synthetic hydrocarbon process oil comprises at least 95 wt % of hydrocarbon oligomers having an average carbon number of 30 carbon atoms.

24. The composition of claim 1, wherein the synthetic hydrocarbon process oil comprises at least 95 wt % of hydrocarbon oligomers having an average carbon number of 32 carbon atoms.

25. The composition of claim 1, wherein the synthetic hydrocarbon process oil is a mixture of trimer and higher oligomers with an average carbon number ≥42.

26. The composition of claim 1, wherein the synthetic hydrocarbon process oil has a kinematic viscosity at 100° C. (KV100) of 3 to 5 cSt, a Noack volatility of 8%, and an initial boiling point >385° C.

27. The composition of claim 1, wherein the synthetic hydrocarbon process oil has a kinematic viscosity at 100° C. (KV100) of 7 to 10 cSt, a Noack volatility of <3%, and an initial boiling point >435° C.

28. The composition of claim 1, wherein the synthetic hydrocarbon process oil has a flash point ≥230° C., as determined according to ASTM D93.

29. The composition of claim 1, wherein the synthetic hydrocarbon process oil has a flash point ≥270° C., as determined according to ASTM D93.

30. The composition of claim 1, wherein the synthetic hydrocarbon process oil has an initial boiling point ≥370° C., as determined according to ASTM D6352.

31. The composition of claim 1, wherein the synthetic hydrocarbon process oil has a UV absorbance of <0.5 at 272 nm, as determined according to ASTM D2269-10.

32. The composition of claim 1, wherein the synthetic hydrocarbon process oil has a UV absorbance of <0.3 at 272 nm, as determined according to ASTM D2269-10.

33. The composition of claim 1, wherein the polymer component is non-polar.

34. The composition of claim 1, wherein the polymer component is an elastomer.

35. The composition of claim 1, wherein the polymer component is a rubber.

36. The composition of claim 1, wherein the polymer component comprises a styrene butadiene rubber.

37. The composition of claim 1, wherein the polymer component comprises an ethylene propylene diene monomer.

38. The composition of claim 1, wherein the polymer component comprises a polybutadiene rubber.

39. The composition of claim 1, wherein the polymer component comprises a butyl rubber.

40. The composition of claim 1, wherein the polymer component comprises a styrene block copolymer.

41. The composition of claim 1, wherein the polymer component comprises a styrene isoprene copolymer.

42. The composition of claim 1, wherein the polymer component is a blend of polymers, wherein at least one of the polymers is compatible with the synthetic hydrocarbon process oil.

43. The composition of claim 1, wherein the polymer component is crosslinked through a process of vulcanization.

44. The composition of claim 1, comprising about 5 to 300 parts per hundred parts polymer, and one or more additives selected from organic or inorganic particulate fillers, organic or inorganic pigments, reinforcing additives, nucleating agents, scorch retarding agents, crosslinking agents, crosslinking co-agents, antioxidants, internal and external lubricating agents, thermal stabilizers, UV-stabilizers, conductive additives, flame retardant additives, and anti-static agents.
